(19) United States
(12) Patent Application Publication
(10) Pub. No.: US 2016/0125963 A1
(43) Pub. Date: May 5, 2016

(54) INTRINSICALLY SAFE NUCLEAR REACTOR

(71) Applicant: Robin Jerry McDaniel, Lake Villa, IL (US)

(72) Inventor: Robin Jerry McDaniel, Lake Villa, IL (US)

(21) Appl. No.: 14/527,356

(22) Filed: Oct. 29, 2014

(51) Int. Cl. G21C 9/00; F04D 13/06; G21C 9/04

(52) U.S. Cl. CPC G21C 9/00; G21C 9/04; F04D 13/06

(57) ABSTRACT

An improved nuclear fission reactor of the liquid metal cooled type including a core configuration allowing for only two operational states, “Power” or “Rest”. The flow of the primary cooling fluid suspends the core in the “Power” state, with sufficient flow to remove the heat to an intermediate heat exchanger during normal operation. This invention utilizes the force of gravity to shut down the reactor after any loss of coolant flow, either a controlled reactor shut down or a “LOCA” event, as the core is controlled via dispersion of fuel elements. Electromagnetic pumps incorporating automatic safety electrical cut-offs are employed to shutdown the primary cooling system to disassemble the core to the “Rest” configuration due to a loss of secondary coolant or loss of ultimate heat sink. This invention is a hybrid pool-loop pressurized high-temperature or unpressurized reactor unique in its use of a minimum number of components, utilizing no moving mechanical parts, no rotating seals, optimized piping, and no control rods. Thus defining an elegantly simple intrinsically safe nuclear reactor.

### FEDERALLY SPONSORED RESEARCH

Not Applicable

### SEQUENCE LISTING OR PROGRAM

Not Applicable

### BACKGROUND TECHNICAL FIELD

This invention relates to nuclear fission reactors in general and more specifically to nuclear fission reactors of the liquid metal cooled type.

### BACKGROUND DESCRIPTION OF PRIOR ART

### References Cited

U.S. Patent Documents

| | | |
|---|---|---|
| 2,798,847 | July 1957 | Fermi et al. |
| 3,046,212 | July 1962 | Anderson |
| 4,293,380 | October 1981 | Robbins |
| 5,202,085 | April 1993 | Aoyama et al. |
| 7,403,585 | Jul. 1, 2004 | Ougouag, et al. |
| 7,139,352 | Nov. 21, 2006 | Nishiguchi, et al. |
| 8,666,016 | Mar. 4, 2014 | Arai, et al. |

Intrinsically safe nuclear fission reactors differ from conventional nuclear fission reactors in that the design is much more elegantly simple, affording simple operation, sealed, eliminating the refueling cycle and attendant removal and transport of fuel, and elimination the potential for nuclear proliferation by the misappropriation of nuclear materials.

Conventional reactor designs include many additional components required to control the reactor; control rods, proportional energy conversion components coupled to the output level of the reactor, and controlled to the demand for electrical energy. Quoting the directors of ten national laboratories in the paper, A Sustainable Energy Future: The Essential Role of Nuclear Energy, published in August of 2008, “a myriad of pumps and valves, miles of piping and wiring . . . . ” Conventional reactors are subject to many critical points of failures of both equipment and human errors.

Even proposed pebble bed reactors comprises a core formed by a plurality of spherically shaped fuel elements or pebbles. The pebbles comprising the core are typically contained in a graphite reflector. A coolant, typically gaseous Helium, is caused to flow through the pebble core and the graphite reflector. The coolant, a leak prone gas, is not very efficient in heat transfer, and current reactor designs utilizing graphite pebbles are envisioned in un-domed above ground buildings. In the event of an introduction of air to the bed, a catastrophic fire may occur.

These proposed designs may not be better or safer that the current generation II or III reactors, and are prone with similar complicated, numerous control, and operational issues as do current conventional nuclear power reactors.

However, the design of an intrinsically safe nuclear reactor also utilizes spherical fuel elements, yet they are never removed from the reactor, and with no moving parts, no rotating seals to be compromised, multiple electromagnetic primary cooling pumps, and gravity assured safety automatic shutdown operation for any foreseeable loss of coolant conditions (as depicted in FIG. 4). These metallic clad fuel spheres can be designed to operate for many dozens of years and the spent fuel is just left in the reactor vessel, deeply buried on site, at the end of the reactor useful life.

Current designs for liquid metal cooled fast reactors utilize a complex core mapping and loading process. Complicated fuel exchange apparatus is used to shuffle fuel assemblies to promote even breeding, including complex time consuming procedures.

Current designs for liquid metal cooled fast reactors utilize unpressurized reactor vessels thus limiting the upper operating temperatures of the system.

Additionally since this intrinsically safe reactor design has a minimal number of components or parts, analysis, critical design review, licensing, certification, manufacture, and operations are inherently simpler and rigorous review is best focused on the balance of plant safety, reliability, and non-technical factors to meet the national energy needs.

### SUMMARY OF THE INVENTION

The present invention is made in view of the aforesaid problems in the related art.

An improved nuclear fission reactor of the intrinsically safe type according to one embodiment of the present invention comprising a system of simple components to support the “core”, transfer the heat of nuclear fission via an intermediate heat exchanger, while utilizing no moving parts, nor mechanical seals, by the principle of electromagnetic pumping (EMP), and utilizing the constant ever-present force of gravity to assure safe shutdown.

A device for the conversion of nuclear energy to high value, high temperature heat, by an intrinsically safe means utilizing a novel collection of components.

This invention utilizes a hybrid pool-loop design to minimize the piping required, minimizing the plumbing components and simplifying design to achieve a minimal number of components therefore facilitating design, construction, and operations. The advantages of a large pool of primary coolant mitigate thermal transients and inter-pool leakage.

A novel means of initiating and controlling the nuclear reaction without the use of control rods, deploying the fuel spheres, the “core”, to start the reaction without employing any moving parts, creating an operation with two steady states; “Power” or “Rest”, either full power output or no nuclear power output and cooling down to “Rest” state with minimum residual decay heat output, therefore, control is simplified.

By its design an intrinsically safe nuclear reactor is automatically self-controlling in the case of loss of coolant incidents, or accidents, as the “core” is supported by the upward flow of the primary coolant. Thus if the flow creases, the “core” is turned to “Rest” state.

The fuel source of an intrinsically safe nuclear reactor comprises a collection of spherical elements or “Fuel Spheres,” each of which may be approximately the size of a tennis ball or golf ball. Said fuel spheres are more dense than the liquid coolant, thus causing them to sink in the absence of upward coolant fluid flow. Each metallic sphere comprises of a plurality of much smaller fuel particles or kernels dispersed in a metallic matrix within the hollow spherical shell. Said hollow spheres are wetted with NaK so as to provide good thermal conductivity from the inside of the shell to the formed fuel element. The fuel comprises a fissionable material that may include any of the known fissionable isotopes, such as, but not limited to, U-235, U-233, or Pu-239, or may also contain fertile isotopes, such as, for example, U-238 or Th-232, that convert to fissile materials upon residence in an operating reactor core. One preferred embodiment fuel alloy would be U-TRU-10% Zr with approximately 10 to 15% TRU content. Additionally a small quantity of a burnable poison e.g. Gadolinium and/or Americium may be incorporated in the fuel spheres to control the rate of the reaction.

The nuclear fuel is in the form of spheres that remain in the reactor vessel for the life of the system, and when decommissioned are abandoned in place in the reactor vessel and may never need to be transported or removed from the vessel.

By providing the reactor with a moderator-to-fuel ratio that is optimally moderated for the asymptotic equilibrium state of the reactor at start-up; allowing the nuclear fission reactor to be continuously operated in an optimally moderated long term state. Essentially operating an isobreeder ratio.

Deep subterranean installation of the reactor primary containment vessel will minimize the exposure to accidental natural and or intentional terrorist events.

Also disclosed is the pressurization of the primary cooling system. In order to operate the reactor at elevated temperatures the primary coolant is required to be maintained for example, NaK at 1000 degrees C., at above 10 atmospheres of pressure.

Also disclosed are a plurality of seismically stabilized supports which isolate the primary containment vessel inside of a larger secondary containment structure.

The pool-loop configuration provides a very large mass of coolant with which to mitigate the thermal transients in the event of a total stoppage of pumping forces. Inertia and convection will provide initial coolant flow to remove the early heat of decay. A steady low flow of coolant will even dissipate longer term heat of decay by both a dual function EMP cooling/DRACS heat removal loop and the natural thermal convection inherent in such a pool-loop design configuration.

In summary, this novel elegantly simple reactor design can be characterized as “Inherently Safe” because of the utilization of the dependable gravitational forces to cause the safe shutdown of the core for all unforeseen events which may cause a loss of coolant accident, (see FIG. 4) “LOCA”, leakage, rupture, or accidental total loss of power to the EM pumps, will bring the system to “Rest”. The loss of secondary cooling, or even failure of the ultimate heat sink, will cause the EM pump thermal-electric breakers to open the circuits to shut off power and thus cease to support the core.

### BRIEF DESCRIPTION OF THE DRAWINGS

Illustrative and presently preferred embodiments of the invention are shown in the accompanying drawings in which:

FIG. 1 is a sectional view of a representation the components of an intrinsically safe nuclear fission reactor according to one embodiment of the present invention;

FIG. 2A is a sectional view of a reactor core chamber of said reactor showing the “Power” state, coolant supported “core” by primary coolant;

FIG. 2B is a sectional view of a reactor core chamber of said reactor showing the “Rest” state, no flow or minimal flow to remove heat of decay, of primary coolant;

FIG. 3 is a sectional view of a design of an electromagnetic pump for the primary coolant (Na, NaK or PbBi, or any magnetic fluid), according to one embodiment of the present invention;

FIG. 4 is a state diagram of the core due to any “LOCA” event.

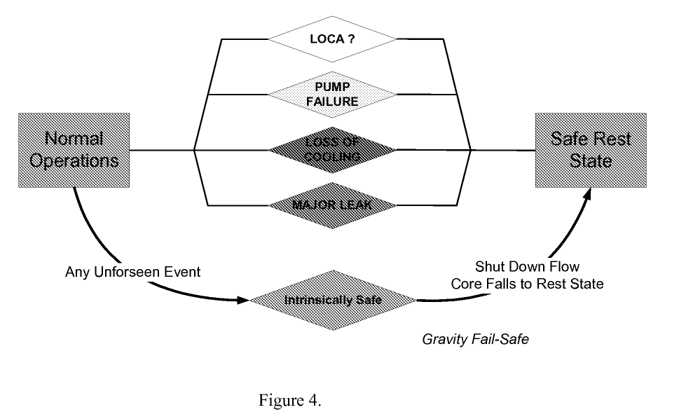

### REFERENCE NUMERALS USED IN DRAWINGS

A Electromagnetic Pumps
B Intermediate Heat Exchanger (IHX)
C Core Assembly
1 Core (Fuel Spheres)
2 Upper Chamber
3 Primary Reactor Containment Vessel
4 Lower Chamber
5 Outlet Screen
6 Inlet Screen
7 Pool Separation Bulkhead
8 Neutron Reflector
9 Outer Neutron Absorber
10 Inner Neutron Absorber
11 Seismic Supports
12 Electromagnetic Pump Coils
13 Secondary Containment Structure
14 Electromagnetic Pump Stators
15 Cool Pool
16 Pump Inlet Pipe
17 Primary Coolant Level
18 Magnetic Pipe to Shield Output
19 Coolant Flow
20 Pump Outlet Pipe
21 Hot Pool

However, before proceeding with the description, it should be noted that the various embodiments shown and described herein are exemplary only and are not intended to represent the extent to which the present invention may be utilized. Indeed, the systems and methods described herein could be readily applied to any of a wide range of intrinsically safe nuclear fission reactor designs, as would be obvious to persons having ordinary skill in the art after having become familiar with the teachings provided herein. Consequently, the present invention should not be regarded as limited to the particular intrinsically safe reactor and example configurations shown and described herein.

### DETAILED DESCRIPTION

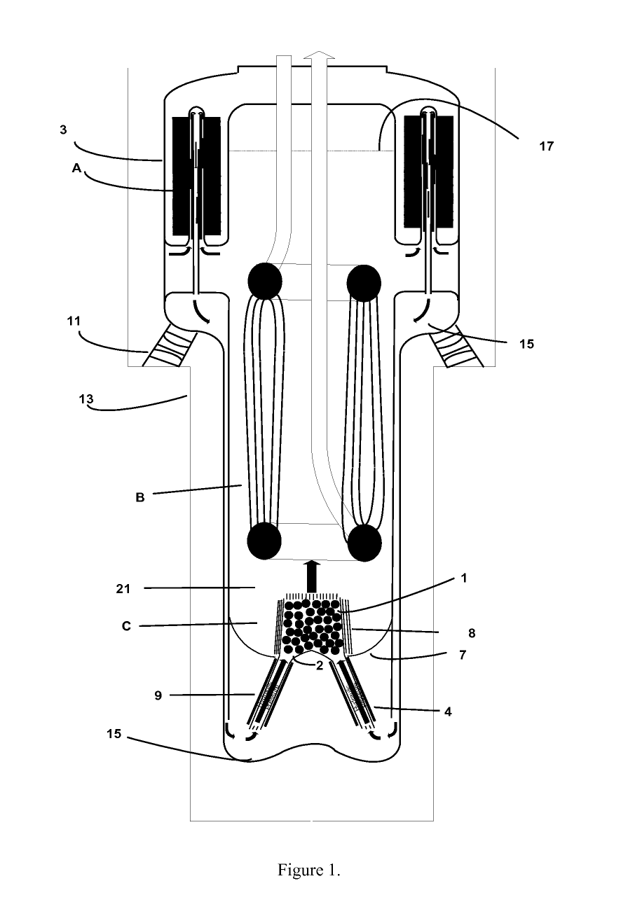

Referring now to FIG. 1, one embodiment of an intrinsically safe nuclear fission reactor may comprise an upper chamber 2 to hold the fuel spheres 1 in to a configuration that supports fission.

When the pumps A are turned on, and sufficient pressure or flow 19 is achieved, the fuel spheres 1 are pushed up (randomly shuffled) into the upper core chamber 2 and it is in the “Power” state. The upper core is surrounded by a reflector 8 which, in one embodiment, comprises a generally cylindrically-shaped side reflector portion that encircles the core chamber. Additional reflectors may also be provided in certain reactor designs. As will be described in greater detail, an inverted cone shaped lower chamber 4 is positioned directly under the core chamber to hold the fuel spheres apart from each other in the “Rest” state, the walls of this chamber are surrounded by neutron moderating, or absorbing materials.

One possible variant of application of the intrinsically safe reactor is in the Fast Reactor or breeder reactor configuration. A system can be provided with a suitable fuel sphere collection system (piping not shown) for collecting the fuel spheres as have become depleted to the extent where it is no longer desirable to operate with them. Partially depleted or enriched fuel may be recycled to a reprocessing unit of the reactor complex, whereas depleted fuel may also be removed from the reprocessing or refueling loop.

Because continuous fueling reactor systems are well-known in the art and could be easily provided by persons having ordinary skill in the art after having become familiar with the teachings provided herein, the nuclear reactor system, as well as the various ancillary systems that may be desired or required for the operation of a fast breeder nuclear reactor system, will not be described in further detail herein.

Fuel spheres having different overall diameters and densities are possible and should be regarded as being within the scope of the present invention, provided suitable modifications are made to the reactor system to allow fuel spheres having different diameters to be used.

### Core Description

Utilizes hollow spheres of enriched uranium or other fissile fuel encased in such a way as to be more dense than the coolant medium, so as to be partially buoyant, yet sink in non-flowing hot primary coolant.

In the coolant, the primary cooling fluid may be an eutectic alloy of Sodium and Potassium (NaK). One possible eutectic mix is liquid from −12.6 to 785° C., and has a density of 866 kg/m³ at 21° C. and 855 kg/m³ at 100° C., making it less dense than water.

The envisioned reactor has only two power states: “Power” or “Rest”.

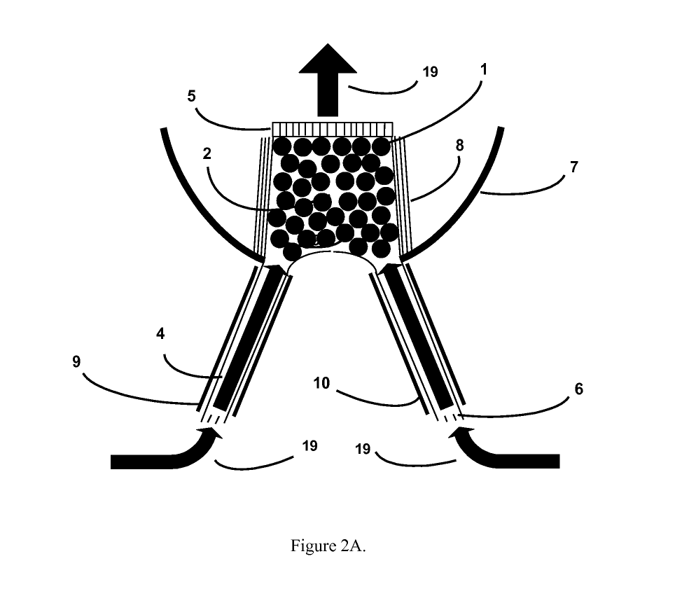

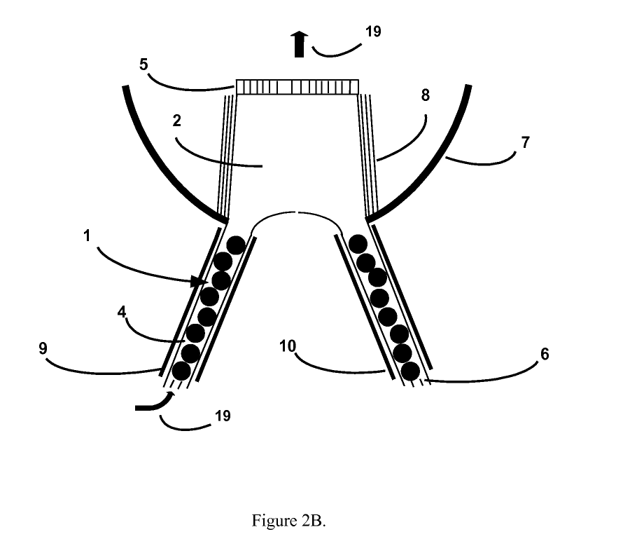

While in the “Power” state, referring to FIG. 2A, the core is formed in a “upper core chamber” 2 held in such a configuration, geometrically collected inside of such chamber surrounded by neutron reflective material 8 in such a way as to allow the core to reach criticality and begin the nuclear fission process, and as the primary cooling fluid 19 flows upwards through the core chambers supporting the “core” it also removes the heat of nuclear fission and transfers the heat up past an outlet screen like structure 5, therefore the pressure of the primary coolant pushes upwards against the constant force of gravity and “holds” the core in the “Power” state.

In the event of a loss of primary coolant flow incident or accident, the core will “fall” or “sink” back into the lower chamber 4 due to gravitational forces into “Rest”, referring to FIG. 2B, chamber and cease to support fission, thus intrinsically safe in all operational conditions. Normal shutdown is achieved by operations turning off the electromagnetic pumps, ceasing the primary coolant flow and shutting down the core. Natural convection can be assisted and nominal low flow rate of primary coolant can be maintained with low power to the EM pumps (FIG. 1. A), to provide cooling of the “Rest” core to remove initial decay heat.

While in the “Rest” state (referring to FIG. 2B), the core is not formed as the primary coolant flow is off, but rather has fallen, sunken down via gravitational forces into a geometrically dispersed, separated configuration surrounded by neutron absorbing materials 9 and 10, the “Rest” chamber 4, thus intrinsically safe as gravity holds the fuel spheres separated and in the absence of the neutron reflector cannot possibly react with each other so as to be unable to support nuclear fission, in the stable “Rest” state,

In the event of a fuel sphere failure, the hollow core of the fuel sphere will fill with coolant and “sink” back into the “Rest” chamber, not contributing to the reaction.

An additional embodiment claimed of the present invention (not shown in the attached drawings) is to utilize multiple lower core chambers as optional sources of fuel spheres supplied by a plurality of flow chambers from a plurality of electromagnetic pumps and pumping power levels. Each lower chamber holding a sufficient quantity of fuel spheres to fill the upper chamber to support fission.

### Pump Description

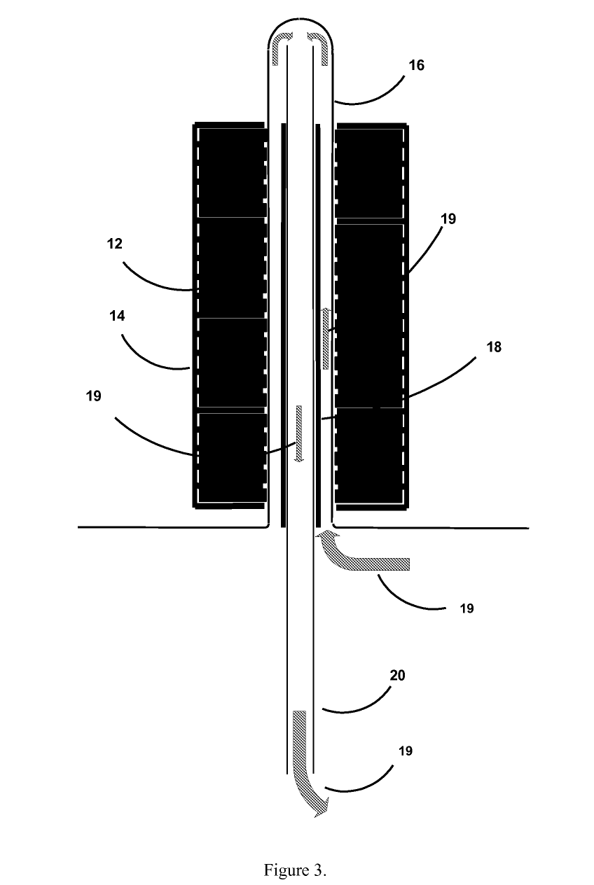

Multiple electromagnetic pumps (EMPs) (FIG. 1 A), refer to FIG. 3, utilizing pump coil and stator assemblies 12 & 14 separated from the pumped fluid, are included to provide redundant unit capacity in the event of partial pump failures, with extra capacity held in reserve,

The primary coolant flows from the upper collection plenum (cool pool 15 above IHX B in FIG. 1) after being cooled (heat energy removed via the IHX) and the pumping forces are applied to the cool side of the working fluid (primary coolant),

Inlet of fluid to the EMP is accomplished by an annulus opening to a pipe 16 where the electromagnetic forces push the liquid metal upwards to the top of the concentric pipes. The return magnetic flux is carried by the concentric magnetic pipe 18 completing the pumping flux.

Output from the electromagnetic pumps is via a relatively short straight pipe 20 thru the center of the pump, shielded from electromagnetic forces via a thick martinetic pipe shield 18. The output pipe 20 is only connected to the top of the distribution chamber, at one end, and thus is allowed to expand in length to minimize stresses inside the pump.

Electromagnetic pumping forces are applied in the outer coaxial space outside of the magnetic shield material 18, with the pump output of coolant reversed in flow down the center space of the pump assembly,

An additional design feature herein claimed is the incorporation of an additional length of concentric pipe(s) 16 & 18 which extends above the zone of electromagnetic pumping forces, a “stand-pipe”, to prevent reverse flow in the event of pump shutdown or failure, due to the remaining EMPs pumping pressure,

An additional design benefit to such an arraignment of coaxial flow is the ease of manufacture of the pumps as the EMP coil assemblies can be easily installed over the pipe assembly.

An additional embodiment claimed of the present invention (not shown in the attached drawings) is to utilize the fluid surrounding the EMP coil assemblies as the in-vessel heat exchanger component of a DRACS loop. In the event of total loss of primary coolant flow the core would return to the “Rest” state, and decay heat would initiate. Direct Reactor Auxiliary Cooling Systems (DRACS) would remove excess decay heat after the initial reserve mass of the cool pool is warmed. Those persons having ordinary skill in the art could readily apply this teaching of a dual purpose fluid to both normal operational cooling of the EMP assemblies and as the component to remove decay heat in the “Rest” state.

A bimetallic thermal-electrical breaker switch (not shown) may be utilized to assure shutdown of the pumping electrical current in the event of an unplanned loss of secondary coolant flow, as when the pumping upper chamber temperature rises above a predetermined point the electricity will be automatically shut off and the pumping forces stopped, therefore the primary coolant flow will stop and the “core” returned to the “Rest” state.

### Intermediate Heat Exchanger (IHX) Description

To assure the intrinsic safety of the whole system, the primary cooling fluid that is in “contact” with the nuclear fuel in the “core” of the reactor is not allowed to leave the primary reactor vessel.

The primary coolant is “pooled”, in two plenums separated by a bulkhead where the outer “pool” is the cool side of the system and the inner “pool” is the hot side of the primary cooling system.

The coolant is forced by pressure differential up through the “core” and is heated by the thermal radiation from the nuclear reaction before flowing upwards through the IHX tubes.

The secondary working fluid, NaK or alternately Pb/Bi or a molten salt, flows from the inlet pipe down to the upper portion of the IHX and into an annular distribution header where a plurality of cooling tubes are connected to the distribution header.

Flow of secondary coolant proceeds down to the lower annular collection header and thereby absorbs heat energy from the primary coolant via conduction and thermal radiation from the “Hot pool 21” directly above the “core” chamber, into the secondary working fluid inside the IHX tubes,

The IHX tubes are manifold, of equal overall length, and are in a spiral shape to mitigate the effects of differential expansion due to the possible differential temperatures in adjacent tubes, this allows the stresses to be spread along the entire tube based on a spiral, spring-like geometry of the individual tubes.

The secondary coolant flows from the reactor to a vaporizer, i.e., steam generator or Brighton Cycle system, to convert the heat to work via conventional evaporation condensation cycles, and thus transferring the energy flows back to the reactor to “cool” the “Hot Pool” once again.

This invention utilizes a plurality of seismic supports 11 which isolate the Primary Reactor Vessel 3 from the secondary containment structure in the event of an earthquake. Said secondary containment structure 13 is constructed on-site and the reactor vessel is delivered to the site as a fully fueled sealed module, then installed, covered and buried.

As a component of a “Hybrid Nuclear Power System”, the Intrinsically Safe Nuclear Reactor, (ISNR), provides high value, high temperature heat to an other energy conversion component (water/steam/water or other vapor cycle thermal to mechanical energy system; to create electricity and distribute the electricity to the community, and waste heat from the energy conversion component also utilizes low value heat to provide district heating and cooling, and to desalinated seawater.

An additional embodiment of the present invention is to utilize the ISNR as a source of high temperature heat for industrial processes, e.g. Steel Processing, or Hydrogen Generation. In this embodiment a reactor output temperature of 900 Deg C. is desired and therefor the reactor vessel shall be pressurized to at least 10 atmospheres in order to maintain Sodium coolant in a liquid phase at that temperature. Those persons having ordinary skill in the art could readily apply high pressure technologies such as required with older pressurized water reactors. One embodiment of the present invention would have stainless steel pressure vessel wall thickness of 30 mm for a 3 meter diameter reactor and yet the stresses resulting from 1000 Degrees Centigrade molten Sodium, other eutectic, or salts, would remain well below allowable limits per ASME design guidelines.

An additional embodiment of the present invention is to utilize the ISNR as a source of high temperature heat to convert existing generation II and III nuclear power plants as the end-of-life-cycle of the older technology units are decommissioned, thereby utilizing the existing site and steam powered electrical generation and distribution equipment.

An additional embodiment of the present invention is to utilize the ISNR as a source of high temperature heat to offset the use of coal, natural gas, or other fossil fuels in existing power plants thereby shifting the source of power to non-carbon dioxide emitting sources, and also utilizing the existing site and steam powered electrical generation and distribution equipment.

In summation, then, because persons having ordinary skill in the art could readily select from one or several component configurations of the design described herein, after having become familiar with the teachings of the present invention, the present invention should not be regarded as limited to varying any one or combination of the reactor components described herein.

Present invention should not be regarded as limited to any kind of cooling fluid.

Present invention should not be regarded as limited to any kind of pump, conventional or electromagnetic.

Present invention should not be regarded as limited to any pressurized or nonpressurized reactor vessel.

Present invention should not be regarded as limited to any scale of power output.

Present invention should not be regarded as limited to any particular fuel source or combination of fuel sources.

Present invention should not be regarded as limited to any installation configuration: subterranean or surface structures, stationary or mobile application as in surface ships, airships, spacecraft, or as small transportable power units for military or civilian applications.

Having herein set forth preferred embodiments of the present invention, it is anticipated that suitable modifications can be made thereto which will nonetheless remain within the scope of the invention. The invention shall therefore only be construed in accordance with the specific included claims.

I claim the invention is:

1. A liquid metal cooled nuclear fission reactor core, in which the heat created by nuclear fission is utilized to generate thermal energy, comprising:
a plurality of nuclear fuel elements in the form of spheres that are of a higher density than the density of the reactor's hot primary cooling fluid, an improvement comprising of a means to hydraulically shuffle the core at the start of each power cycle;
a lower core chamber surrounded by neutron absorbers and geometrically shaped so as to hold said fuel spheres in a configuration that will not support fission;
an upper core chamber surrounded by neutron reflectors and geometrically shaped so as to hold said fuel spheres in a configuration that will support fission, the improvement comprising of: (a) a method to control the operation of the reactor while upwards primary coolant hydraulic flow maintains said core, (b) making said core automatically self-deactivating in the event of any loss in primary coolant flow causing the constant force of gravity to assure the safe shutdown of said core, and (c) wherein no control rods are provided within said core.

2. An intrinsically safe nuclear reactor of a liquid metal cooled design with a core according to claim 1, comprising:
A primary containment reactor pressure vessel, the improvement comprising: (a) a configuration wherein all pipes and cables penetrate the vessel wall above the maximum primary coolant level so as to avoid coolant leakage, (b) a lower end shaped in a reverse dimple in such a manner to disperse any loose fuel elements of said core so as not to re-concentrate fuel elements due to gravity, (c) a system of seismic isolation supports which decouple the mass of the reactor from the secondary containment structure in the event of earthquakes, and (d) a configuration which allows for operations at very high temperatures for liquid metal coolants to remain in the liquid phase, at elevated pressures;
an intermediate heat exchanger located directly over the core in the hot pool, the improvement comprising: (a) a location directly proximate to the core as there are no control rods utilized, (b) the minimization of the volume and mass of the hot pool primary coolant with respect to the much larger volume and mass of the cool pool coolant, and (c) allowing for mitigation of thermal transients by having a large proportion of cooler coolant in the reactor in the event of unexpected loss of coolant flow resultant shutdown and decay heat removal;
a plurality of electromagnetic pumps utilized to provide hydraulic flow and pressure to operate said reactor, the improvement comprising: (a) an electromagnetic pump with no moving parts, (b) wherein an internal electrical fuse or thermal circuit breaker designed to shut off power to the pump coils is set at a temperature above the normal primary coolant return temperature, making said core automatically self-deactivating in the event of any loss in secondary coolant flow causing heat to remain in the reactor, and with resulting loss of primary flow, the constant force of gravity assures the safe shutdown of said core without any control signals from outside of the reactor, and (c) the pump housing by virtue of its immersion in and proximity to the primary cooling fluid may also function as an in-reactor pool heat exchanger component of a DRACS loop to remove decay heat during the “Rest” state.
